(19) United States
(12) Patent Application Publication
(10) Pub. No.: US 2024/0271930 A1
(43) Pub. Date: Aug. 15, 2024

(54) SYSTEM AND METHOD FOR DETECTING SPEED BUMPS IN NEAR REAL-TIME

(71) Applicant: Toyota Motor Engineering & Manufacturing North America, Inc., Plano, TX (US)

(72) Inventors: Emrah A. Sisbot, Mountain View, CA (US); Yashar Zeiynali Farid, Mountain View, CA (US); Xiaofei Cao, Mountain View, CA (US); Haritha Muralidharan, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/168,287

(22) Filed: Feb. 13, 2023

(51) Int. Cl. G01B 21/30

(52) U.S. Cl. CPC G01B 21/30

(57) ABSTRACT

A vehicle system of a vehicle may include comprising a controller programmed to obtain rotational speeds of a plurality of wheels of the vehicle at a plurality of time steps, determine a difference between speeds of one or more front wheels of the vehicle and speeds of one or more rear wheels of the vehicle at the plurality of time steps to generate wheel speed differential data, perform a wavelet transform of the wheel speed differential data to generate a continuous wavelet transform spectrum, identify one or more hot spots in the continuous wavelet transform spectrum comprising a plurality of data points having an amplitude within a predetermined frequency range greater than a predetermined detection threshold, and determine locations of one or more speed bumps based on the identified one or more hot spots.

### TECHNICAL FIELD

The present specification relates to detecting speed bumps in near real-time.

### BACKGROUND

Speed bumps are designed to slow down drivers. Their locations are typically marked through signage and/or road paints. However, these markings may deteriorate over time, resulting in speed bumps being difficult to notice. If a driver does not adequately slow down before reaching a speed bump, a speed bump can easily damage a vehicle. Furthermore, appropriate speeds for driving over a speed bump may vary depending on the size of the speed bump. Accordingly, a system and method for detecting speed bumps in near real-time may be desirable.

### SUMMARY

In an embodiment, a vehicle system of a vehicle may include a controller programmed to obtain rotational speeds of a plurality of wheels of the vehicle at a plurality of time steps, determine a difference between speeds of one or more front wheels of the vehicle and speeds of one or more rear wheels of the vehicle at the plurality of time steps to generate wheel speed differential data, perform a wavelet transform of the wheel speed differential data to generate a continuous wavelet transform spectrum, identify one or more hot spots in the continuous wavelet transform spectrum comprising a plurality of data points having an amplitude within a predetermined frequency range greater than a predetermined detection threshold, and determine locations of one or more speed bumps based on the identified one or more hot spots.

In another embodiment, a method may include obtaining rotational speeds of a plurality of wheels of the vehicle at a plurality of time steps, determining a difference between speeds of one or more front wheels of the vehicle and speeds of one or more rear wheels of the vehicle at the plurality of time steps to generate wheel speed differential data, performing a wavelet transform of the wheel speed differential data to generate a continuous wavelet transform spectrum, identifying one or more hot spots in the continuous wavelet transform spectrum comprising a plurality of data points having an amplitude within a predetermined frequency range greater than a predetermined detection threshold, and determining locations of one or more speed bumps based on the identified one or more hot spots.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example environment for detecting speed bumps, according to one or more embodiments shown and described herein;

FIG. 2 depicts a schematic diagram of a vehicle system, according to one or more embodiments shown and described herein;

FIG. 3 depicts the memory modules of the vehicle system of FIG. 2, according to one or more embodiments shown and described herein;

FIG. 4A depicts an example continuous wavelet transform amplitude spectrum, according to one or more embodiments shown and described herein;

FIG. 4B depicts an annotated example continuous wavelet transform amplitude spectrum, according to one or more embodiments shown and described herein; and

FIG. 5 depicts a flowchart of an example method of operating the vehicle system of FIG. 2 to detect speed bumps, according to one or more embodiments shown and described herein.

### DETAILED DESCRIPTION

The embodiments disclosed herein include a system and method for detecting speed bumps in near real-time. One or more vehicle sensors may monitor the rotational speeds of the wheels of a vehicle. When a vehicle interacts with a speed bump (e.g., by driver over the speed bump), the rotational speeds of the wheels of the vehicle may vary in an oscillating manner. As such, a vehicle system may monitor the rotational speeds of the wheels and use a difference between the rotational speeds of different wheels to create an energy normalized wavelet spectrum, as disclosed herein. The vehicle system may then determine the presence and characteristics of a speed bump based on the energy normalized wavelet spectrum, as disclosed herein. When a speed bump is detected, the vehicle system may transmit the location of the speed bump to a server or to other vehicles to make other drivers aware of the location of the detected speed bump.

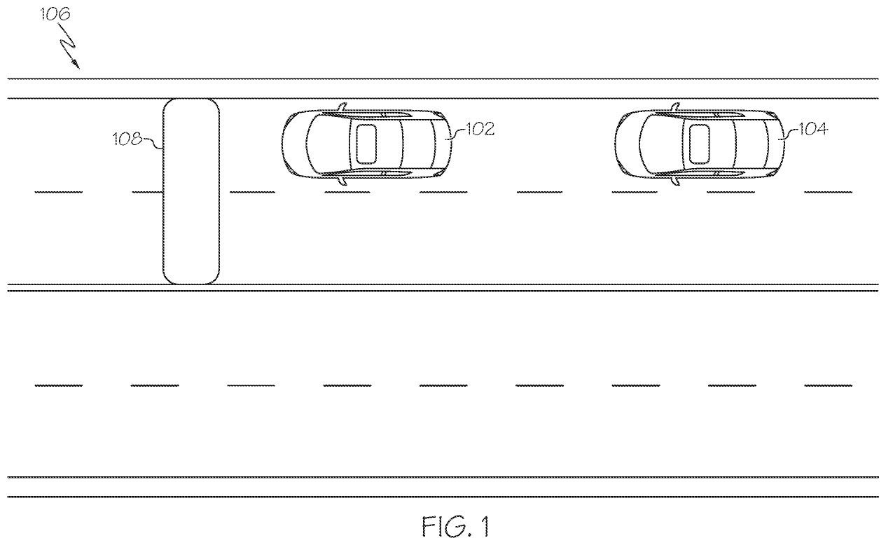

Turning now to the figures, FIG. 1 schematically depicts a scenario in which speed bump detection may be implemented. In the example of FIG. 1, vehicles 102 and 104 drive along a road 106. The vehicle 102 is approaching a speed bump 108. While the illustrated example is directed to detecting speed bumps, in other examples, other road anomalies may be detected using the techniques described herein, such as pot holes or other obstacles or obstructions that may be located along a road.

When the vehicle 102 interacts with the speed bump 108, the vehicle 102 may detect the presence of the speed bump 108, using the techniques disclosed herein. After the speed bump 108 is detected, the vehicle 102 may transmit the location of the speed bump 108 to the vehicle 104, for example, by using vehicle-to-vehicle communication. Upon receiving the location of the speed bump 108, the driver of the vehicle 104, or an autonomous driving feature of the vehicle 104, may adjust the speed of the vehicle 104 as it approaches the location of the speed bump 108 so as to driver over the speed bump 108 at an appropriate speed.

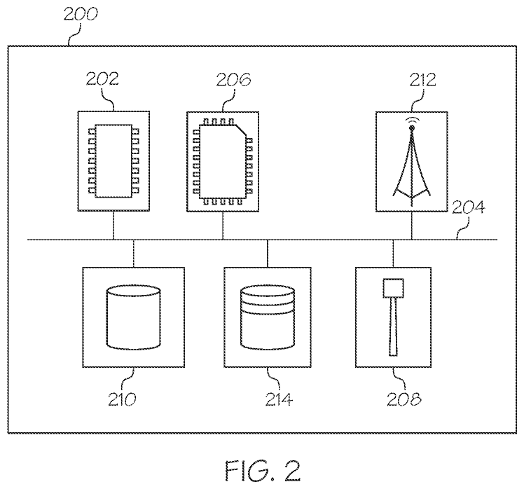

FIG. 2 depicts a vehicle system 200 that may be included in the vehicle 102 and/or the vehicle 104 of FIG. 1. In the example of FIG. 2, the vehicle system 200 includes one or more processors 202, a communication path 204, one or more memory modules 206, a satellite antenna 208, one or more vehicle sensors 210, a network interface hardware 212, and a data storage component 214, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1 GL, 2 GL, 3 GL, 4 GL, or 5 GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, equipment sensors, LiDAR sensors, RADAR sensors, optical sensors (e.g., cameras, laser sensors), proximity sensors, location sensors (e.g., GPS modules), and the like. In embodiments, the vehicle sensors 210 may monitor the rotational speeds of the four wheels of the vehicle 102. In embodiments, the vehicle sensors 210 may also monitor the gear in which the vehicle 102 is operating.

Still referring to FIG. 2, the vehicle system 200 comprises network interface hardware 212 for communicatively coupling the vehicle system to one or more external devices, such as a remote computing device (e.g., a cloud server or edge server) or other vehicles (e.g., the vehicle 104 of FIG. 1). The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 212 includes hardware configured to operate in accordance with the Bluetooth® wireless communication protocol. In embodiments, the network interface hardware 212 of the vehicle system 200 may transmit determined locations of speed bumps, as disclosed in further detail below.

Still referring to FIG. 2, the vehicle system 200 comprises a data storage component 214. The data storage component 214 may store data used by various components of the vehicle system 200. For example, the data storage component 214 may store sensor data collected by the vehicle sensors 210 and/or determined locations of speed bumps.

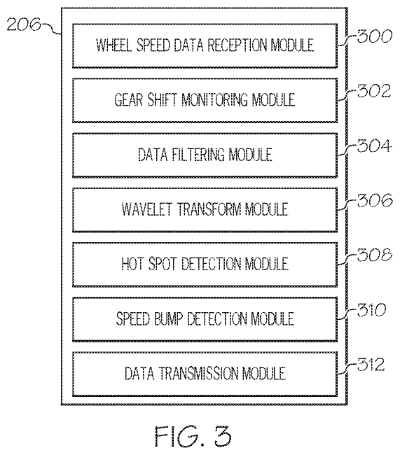

Now referring to FIG. 3, the one or more memory modules 206 of the vehicle system 200 include a wheel speed data reception module 300, a gear shift monitoring module 302, a data filtering module 304, a wavelet transform module 306, a hot spot detection module 308, a speed bump detection module 310, and a data transmission module 312. Each of the wheel speed data reception module 300, the gear shift monitoring module 302, the data filtering module 304, the wavelet transform module 306, the hot spot detection module 308, the speed bump detection module 310, and the data transmission module 312 may be a program module in the form of operating systems, application program modules, and other program modules stored in the one or more memory modules 206. In some examples, the program module may be stored in a remote storage device that may communicate with the vehicle system 200. Such a program module may include, but is not limited to, routines, subroutines, programs, objects, components, data structures and the like for performing specific tasks or executing specific data types as will be described below.

The wheel speed data reception module 300 may receive sensor data indicating the rotational speed of each of the four wheels of the vehicle (the left front wheel, the right front wheel, the left rear wheel, and the right rear wheel). The wheel rotational speeds may be monitored by the one or more vehicle sensors 210. When the vehicle 102 drives over a speed bump, the front wheels of the vehicle 102 encounter the speed bump before the rear wheels encounter the speed bump. As such, when the front wheels of the vehicle 102 encounter the speed bump, their rotational speed will change relative to that of the rear wheels of the vehicle 102. In particular, a difference between the rotational speeds of the front and rear wheels of the vehicle 102 may oscillate at certain frequencies. The frequencies of such oscillations may be used to identify that a speed bump has been encountered, as disclosed herein. In embodiments, the wheel speed data reception module 300 may continually receive the rotational speeds of the wheels of the vehicle 102. In one example, the wheel speed data reception module 300 may receive this data every second. However, in other examples, the wheel speed data reception module 300 may receive this data at any other interval.

The gear shift monitoring module 302 may monitor the gear in which the vehicle 102 is operating and may detect any gear shifts by the vehicle 102. As discussed above, when the vehicle 102 encounters a speed bump, a difference between the front and rear wheel speeds of the vehicle 102 may be observed as oscillations. However, such oscillations in the difference between the front and rear wheel speeds of the vehicle 102 may also occur when the vehicle 102 shifts gears. Thus, by monitoring when the vehicle 102 shifts gears, the vehicle system 200 may distinguish between a detected wheel speed difference caused by a speed bump, and a detected wheel speed difference caused by a gear shift.

The data filtering module 304 may filter out wheel speed data gathered during gear shifts by the vehicle 102, as detected by the gear shift monitoring module 302. In particular, the data filtering module 304 may filter out wheel speed data collected within a predetermined interval of time before and after a gear shift (e.g., less than one second before a gear shift and less than one second after a gear shift). This may allow the vehicle system 200 to avoid mistaking a gear shift for a speed bump, as discussed above. Filtering out wheel speed data gathered during gear shifts may comprise generating filtered data by setting wheel speed data collected during the predetermined interval around a gear shift to the same value for all four wheels of the vehicle 102 (e.g., a rotational speed of 0). This may ensure that there is no wheel speed difference between the wheels of the vehicle 102 in the filtered data when a gear shift occurs.

The wavelet transform module 306 may perform a wavelet transform of data comprising a difference between front and rear wheel speeds of the vehicle 102 based on the filtered data generated by the data filtering module 304. That is, the wavelet transform module 306 may perform a wavelet transform of the difference between the rotational speeds of the front wheels of the vehicle 102 and the rotational speeds of the rear wheels of the vehicle 102 with data gathered during vehicle gear shifts filtered out.

In some examples, the wavelet transform module 306 may perform a wavelet transform of a difference between the rotational speeds of the right front wheel and the right rear wheel of the vehicle 102. As such, the wavelet transform module 306 may generate a continuous wavelet transform amplitude spectrum of the difference between rotational speeds of the front and rear wheels of the vehicle 102. As discussed above, when the vehicle 102 encounters a speed bump, the difference in rotational speed between the front and rear wheels of the vehicle 102 may oscillate. Accordingly, the wavelet transform module 306 may generate a wavelet transform spectrum that indicates the frequency components of these oscillations at different time steps.

In some examples, the wavelet transform module 306 may perform a wavelet transform of a difference between the rotational speeds of the left front wheel and the left rear wheel of the vehicle 102. In some examples, the wavelet transform module 306 may perform a wavelet transform of a difference between the average rotational speeds of the front wheels and the average rotational speeds of the rear wheels of the vehicle 102. In other examples, the wavelet transform module 306 may perform a first wavelet transform of a difference between the rotational speeds of the right front wheel and the right rear wheel of the vehicle 102, and a second wavelet transform of a difference between the rotational speeds of the left front wheel and the left rear wheel of the vehicle 102.

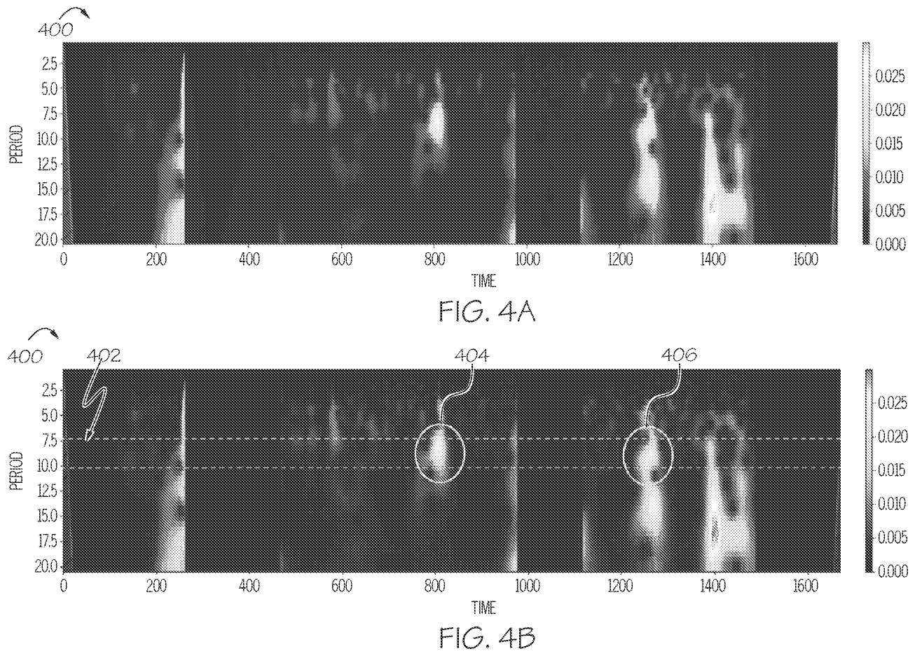

The wavelet transform generated by the wavelet transform module 306 may generate time series data indicating intensities of various frequency components of the difference between the rotational speeds of the front and rear wheels of the vehicle 102. FIG. 4A illustrates an example wavelet transform 400 that may be generated for example data. In the wavelet transform 400 of FIG. 4A, the x-axis represents time (e.g., seconds), the y-axis represents period (e.g., milliseconds), and the shading at each point of the wavelet transform 400 indicates an intensity of a particular frequency component at a particular time. In the example of FIG. 4A, the data around 400 seconds, 1000 seconds, and 1600 seconds has been filtered out by the data filtering module 304 because a gear shift was detected by the gear shift monitoring module 302 during those time intervals.

In some examples, the wavelet transform module 306 may generate a normalized continuous wavelet transform spectrum by dividing the generated wavelet transform by the speed of the vehicle 102 at each point in time during which data was collected. When the vehicle 102 interacts with a speed bump, the intensity of the amplitude of the continuous wavelet transform depends on the impact intensity, which is correlated to how sever the speed bump is and how fast the vehicle is driving over the speed bump. As such, dividing the generated wavelet transform by the vehicle speed generates a normalized wavelet transform that is invariant to vehicle speed. That is, the normalized wavelet transform may indicate the severity (e.g., the size) of speed bumps independent of the speed of the vehicle 102.

The hot spot detection module 308 may detect hot spots in the normalized continuous wavelet transform spectrum generated by the wavelet transform module 306, as disclosed herein. As discussed above, when the vehicle 102 interacts with a speed bump, the difference in rotational speed between the front and rear wheels tends to oscillate. In particular, the difference in rotational speed between the front and rear wheels tends to oscillate at a particular frequency or frequencies depending on various characteristics of the vehicle 102. As such, for any particular vehicle (e.g., the vehicle 102 of FIG. 1), experiments may be performed to determine a range of frequencies at which the difference between front and rear wheel speeds tends to oscillate when a speed bump is encountered. This frequency range may be stored in the data storage component 214.

The hot spot detection module 308 may search the wavelet transform spectrum generated by the wavelet transform module 306 for hot spots within a predefined frequency range. In particular, the hot spot detection module 308 may search the wavelet transform spectrum for hot spots within a predefined frequency range associated with the vehicle 102 (e.g., a frequency range in which the difference between front and rear wheel speeds tends to oscillate when a speed bump is encountered, as discussed above). FIG. 4B shows the example continuous wavelet transform amplitude spectrum of FIG. 4A with the predetermined frequency range 402 indicated.

In embodiments, the hot spot detection module 308 may identify a hot spot when an amplitude of a frequency component within the predetermined frequency range is above a predetermined detection threshold at a plurality of consecutive time steps. In some examples, the predetermined detection threshold may be determined experimentally based on known interactions with speed bumps. FIG. 4B shows two hot spots 404, 406 within the predetermined frequency range 402 that may be identified by the hot spot detection module 308.

In some examples, the hot spot detection module 308 may discard hot spots for which the energy within the predetermined frequency range is not significantly greater than energy outside the predetermined frequency range at the same time steps, as disclosed herein. As discussed above, when the vehicle 102 interacts with a speed bump, the difference in wheel speeds between the front and rear wheels tends to oscillate within a certain frequency range. As such, when a hot spot is detected in the wavelet transform spectrum only within the predetermined frequency range, it is likely that a speed bump was encountered. This can be seen in the hot spot 404 in the example of FIG. 4B. The hot spot 404 includes significant energy at frequencies within the predetermined frequency range 402 and very little energy at frequencies outside of the predetermined frequency range 402. Thus, it is likely that hot spot 404 represents an interaction between the vehicle 102 and a speed bump.

However, if the wavelet transform spectrum indicates significant energy at frequencies within the predetermined frequency range and also outside of the predetermined frequency range, it is likely that this was caused by noise or features other than a speed bump. In the example of FIG. 4B, the hot spot 406 includes significant energy at frequencies within the predetermined frequency range 402 and also outside of the predetermined frequency range 402. Thus, it is likely that the hot spot 406 was caused by something other than a speed bump. Accordingly, the hot spot detection module 308 may discard or filter out the hot spot 406.

In embodiments, the hot spot detection module 308 may discard hot spots whose average energy within the predetermined frequency range is less than β*E, where β is a predefined multiplier (e.g., 1.2), and E is the average energy in one or more frequency ranges outside the predetermined frequency range. For example, E may be the average energy in a frequency range 20% above the predetermined frequency range or 20% below the predetermined frequency range. However, it should be understood that these values of β and E are merely exemplary. In other examples, any values for β and E may be chosen.

Referring back to FIG. 3, the speed bump detection module 310 may identify a speed bump based on the detection made by the speed bump detection module 310. In particular, for each hot spot identified by the hot spot detection module 308, the speed bump detection module 310 may determine the location of the vehicle 102 when the data associated with the detected hot spot was recorded (e.g., using GPS data). The speed bump detection module 310 may then identify each determined location as having a speed bump. In some examples, the speed bump detection module 310 may identify the location of the speed bump based on the center of an identified hot spot. For example, with respect to the wavelet transform spectrum of FIG. 4B, the hot spot detection module 308 may identify the hot spot 404, as discussed above. Accordingly, because the hot spot 404 is centered around 800 seconds, the speed bump detection module 310 may determine that a speed bump is located at the location of the vehicle 102 at 800 seconds, when the data associated with the hot spot 404 was recorded.

In some examples, the speed bump detection module 310 may detect the size of speed bumps, as disclosed herein. As discussed above, the amplitude of the normalized wavelet transform spectrum when the vehicle 102 interacts with a speed bump is dependent only on the size of the speed bump, independent of the speed of the vehicle 102. As such, after the speed bump detection module 310 determines a location of a speed bump, using the techniques described above, the speed bump detection module 310 may determine the size of the identified speed bump based on the amplitude of the hot spot associated with the identified speed bump. For example, the speed bump detection module 310 may determine the size of an identified speed bump based on the average energy associated with an identified hot spot (e.g., higher energy may correlate to a larger speed bump).

Referring back to FIG. 3, the data transmission module 312 may transmit data indicating a location of an identified speed bump. The data transmission module 312 may transmit this data to other vehicles, to an edge server, to a road side unit, to a cloud computing device, or other entities (e.g., using vehicle-to-vehicle communication, vehicle-to-everything communication, or any other mode of communication). By transmitting the location of an identified speed bump to other entities, other vehicles approaching the speed bump location may be made aware of the speed bump. For instance, in the example of FIG. 1, when the vehicle 102 passes over the speed bump 108, the location of the speed bump 108 may be identified using the techniques described herein. The data transmission module 312 may then transmit the determined location to the vehicle 104. As such, when the vehicle 104 approaches the speed bump 108, the driver of the vehicle 104 or an autonomous driving system may reduce the speed of the vehicle 104 so as to drive over the speed bump 108 at an appropriate speed. In some examples, the data transmission module 312 may transmit data to another vehicle that causes that vehicle to automatically slow down as it approaches a location of an identified speed bump.

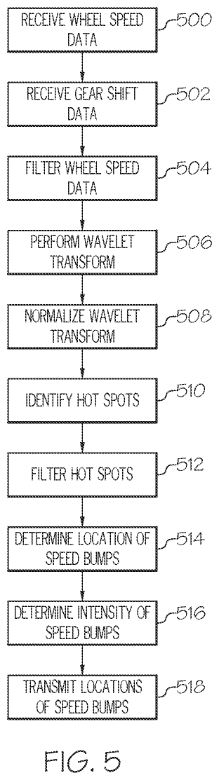

FIG. 5 depicts a flowchart of an example method of operating the vehicle system 200 to detect speed bumps in near real-time. At step 500, the wheel speed data reception module 300 receives wheel speed data associated with the vehicle 102. In particular, the wheel speed data reception module 300 may receive rotational speeds of the four wheels of the vehicle 102 at a plurality of time steps.

At step 502, the gear shift monitoring module 302 receives gear shift data. In particular, the gear shift monitoring module 302 may receive time steps at which the vehicle 102 was shifting gears.

At step 504, the data filtering module 304 filters the wheel speed data received by the wheel speed data reception module 300 based on the gear shift data received by the gear shift monitoring module 302. In particular, the data filtering module 304 may filter out wheel speed data collected during time steps when the vehicle 102 was shifting gears to generate filtered wheel speed data.

At step 506, the wavelet transform module 306 performs a wavelet transform of the filtered wheel speed data. In particular, the wavelet transform module 306 may generate a continuous wavelet transform amplitude spectrum based on a difference in rotational speeds between one or both of the front wheels of the vehicle 102 and one or both of the rear wheels of the vehicle 102.

At step 508, the wavelet transform module 306 normalizes the generated wavelet transform spectrum. In particular, the wavelet transform module 306 may divide the amplitudes of the wavelet transform module 306 at each time step by the speed of the vehicle 102 at the corresponding time steps.

At step 510, the hot spot detection module 308 identifies hot spots in the normalized wavelet transform spectrum. In particular, the hot spot detection module 308 may identify portions of the normalized wavelet transform spectrum where the amplitude within a predetermined frequency range is greater than a predetermined detection threshold. The predetermined frequency range and the predetermined detection threshold may be experimentally determined based on the particular characteristics of the vehicle 102.

At step 512, the hot spot detection module 308 filters the identified hot spots. In particular, the hot spot detection module 308 may filter out hot spots for which the average energy within the predetermined frequency range is not more than a threshold amount greater than the average energy within one or more frequency ranges outside of the predetermined frequency range.

At step 514, the speed bump detection module 310 determines locations of one or more speed bumps. In particular, the speed bump detection module 310 may determine the locations of one or more speed bumps based on the location of the vehicle 102 when the data associated with one or more hot spots was collected.

At step 516, the speed bump detection module 310 determines intensities of one or more identified speed bumps. In particular, the speed bump detection module 310 may determine intensities of one or more speed bumps based on amplitudes associated with one or more identified hot spots.

At step 518, the data transmission module 312 transmits the locations of identified speed bumps. In particular, the data transmission module 312 may transmit the locations of identified speed bumps to an edge server, a road-side unit, a cloud computing device, or other vehicles.

It should now be understood that embodiments described herein are directed to a system and method for detecting speed bumps in near real-time. By continuously collecting wheel speed data, speed bumps may be identified based on normalized continuous wavelet transform spectrums, as disclosed herein. The wavelet transforms may be generated in near real-time such that speed bump locations can be identified in near real-time utilizing the techniques described herein. When a vehicle identifies a speed bump, the vehicle may transmit the location of the identified speed bump to other vehicles. As such, as other vehicles approach the location of the identified speed bump, drivers may be aware of the speed bump even if they cannot easily see the speed bump. Accordingly, drivers may slow down to ensure they driver over the speed bump at an appropriate speed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle system of a vehicle comprising a controller programmed to:
obtain rotational speeds of a plurality of wheels of the vehicle at a plurality of time steps;
determine a difference between speeds of one or more front wheels of the vehicle and speeds of one or more rear wheels of the vehicle at the plurality of time steps to generate wheel speed differential data;
perform a wavelet transform of the wheel speed differential data to generate a continuous wavelet transform spectrum;
identify one or more hot spots in the continuous wavelet transform spectrum comprising a plurality of data points having an amplitude within a predetermined frequency range greater than a predetermined detection threshold; and
determine locations of one or more speed bumps based on the identified one or more hot spots.

2. The vehicle system of claim 1, wherein the controller is programmed to:
determine the locations of the one or more speed bumps based on the location of the vehicle when the data points associated with the one or more hot spots were collected.

3. The vehicle system of claim 1, wherein the controller is programmed to:
determine sizes of the one or more speed bumps based on amplitudes of the data points within the identified one or more hot spots.

4. The vehicle system of claim 1, wherein the controller is programmed to:
receive gear shift data comprising time steps during which a gear shift of the vehicle occurred;
filter out the wheel speed differential data at the time steps during which a gear shift occurred to generate filtered wheel speed differential data; and
perform the wavelet transform of the filtered wheel speed differential data to generate the continuous wavelet transform spectrum.

5. The vehicle system of claim 1, wherein the controller is programmed to:
divide the data points at each time step of the continuous wavelet transform spectrum by a speed of the vehicle at each time step to generate a normalized continuous wavelet transform spectrum; and
identify the one or more hot spots in the normalized continuous wavelet transform spectrum.

6. The vehicle system of claim 1, wherein the predetermined frequency range comprises a range of frequencies within which the wheel speed differential data oscillates when the vehicle encounters a speed bump.

7. The vehicle system of claim 1, wherein the predetermined detection threshold comprises an amplitude at which the wheel speed differential data oscillates when the vehicle encounters a speed bump.

8. The vehicle system of claim 1, wherein the controller is programmed to:
identify a subset of the identified one or more hot spots for which an average energy within the predetermined frequency range at a first plurality of time steps is less than the average energy within one or more frequency ranges outside the predetermined frequency range at the first plurality of time steps multiplied by a predetermined multiplier;
filter the identified one or more hot spots by removing the subset of the identified one or more hot spots to generate one or more filtered hot spots; and
determine the locations of the one or more speed bumps based on the one or more filtered hot spots.

9. The vehicle system of claim 1, wherein the controller is programmed to transmit the locations of the one or more speed bumps to one or more other vehicles.

10. The vehicle system of claim 1, wherein the controller is programmed to transmit the locations of the one or more speed bumps to a remote computing device.

11. A method comprising:
obtaining rotational speeds of a plurality of wheels of a vehicle at a plurality of time steps;
determining a difference between speeds of one or more front wheels of the vehicle and speeds of one or more rear wheels of the vehicle at the plurality of time steps to generate wheel speed differential data;
performing a wavelet transform of the wheel speed differential data to generate a continuous wavelet transform spectrum;
identifying one or more hot spots in the continuous wavelet transform spectrum comprising a plurality of data points having an amplitude within a predetermined frequency range greater than a predetermined detection threshold; and
determining locations of one or more speed bumps based on the identified one or more hot spots.

12. The method of claim 11, further comprising:
determining the locations of the one or more speed bumps based on the location of the vehicle when the data points associated with the one or more hot spots were collected.

13. The method of claim 11, further comprising:
determining sizes of the one or more speed bumps based on amplitudes of the data points within the identified one or more hot spots.

14. The method of claim 11, further comprising:
receiving gear shift data comprising time steps during which a gear shift of the vehicle occurred;
filtering out the wheel speed differential data at the time steps during which a gear shift occurred to generate filtered wheel speed differential data; and
performing the wavelet transform of the filtered wheel speed differential data to generate the continuous wavelet transform spectrum.

15. The method of claim 11, further comprising:
dividing the data points at each time step of the continuous wavelet transform spectrum by a speed of the vehicle at each time step to generate a normalized continuous wavelet transform spectrum; and
identifying the one or more hot spots in the normalized continuous wavelet transform spectrum.

16. The method of claim 11, wherein the predetermined frequency range comprises a range of frequencies within which the wheel speed differential data oscillates when the vehicle encounters a speed bump.

17. The method of claim 11, wherein the predetermined detection threshold comprises an amplitude at which the wheel speed differential data oscillates when the vehicle encounters a speed bump.

18. The method of claim 11, further comprising:
identifying a subset of the identified one or more hot spots for which an average energy within the predetermined frequency range at a first plurality of time steps is less than the average energy within one or more frequency ranges outside the predetermined frequency range at the first plurality of time steps multiplied by a predetermined multiplier;
filtering the identified one or more hot spots by removing the subset of the identified one or more hot spots to generate one or more filtered hot spots; and
determining the locations of the one or more speed bumps based on the one or more filtered hot spots.

19. The method of claim 11, further comprising:
transmitting the locations of the one or more speed bumps to one or more other vehicles.

20. The method of claim 11, further comprising:
transmitting the locations of the one or more speed bumps to a remote computing device.
